(19) United States
(12) Patent Application Publication
(10) Pub. No.: US 2008/0095646 A1
(43) Pub. Date: Apr. 24, 2008

(54) Electrically Driven Compressor Integral with Inverter Device, and Vehicle Air Conditioner Where the Compressor is Used

(75) Inventors: Nobuyuki Nishii, Shiga (JP); Naomi Goto, Shiga (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/569,409

(22) PCT Filed: Apr. 28, 2005
(86) PCT No.: PCT/JP05/08141

§ 371 Date: Nov. 20, 2006

(30) Foreign Application Priority Data
May 20, 2004 (JP) 2004-149988
Mar. 11, 2005 (JP) 2005-069092

(51) Int. Cl. F04B 39/00; B60H 1/22

(52) U.S. Cl. 417/411

(57) ABSTRACT

The electrically driven compressor integrally formed with an inverter device contains compression mechanism section (28); motor (31) as a power source of the compression mechanism section; metal housing (32) for accommodating the compression mechanism section and the motor; inverter device (20), which is disposed outside the metal housing, for supplying electricity to the motor; and electric connection terminal (8) for electrically connecting between an inside and an outside of the metal housing. The electric connection terminal has pin terminal (10) formed of a metal with low thermal conductivity and a metal with high thermal conductivity plated on the metal with low thermal conductivity. The pin terminal is electrically connected to the inverter device by solder (9).

This application is a U.S. National Phase application of PCT International Application PCT/JP2005/008141.

### TECHNICAL FIELD

The present invention relates to an electrically driven compressor integrally formed with an inverter device, a motor and a compression mechanism section.

### BACKGROUND ART

FIG. 8 shows electrically driven compressor 106 having a sensorless DC brushless motor as an example of conventional electrically driven compressors. In FIG. 8, metal housing 132 accommodates compression mechanism section 128, motor 131 and the like. Refrigerant is sucked through inlet 133 and then compressed by compression mechanism section 128, (although a scroll mechanism is used in the example) driven by motor 131. The compressed refrigerant cools motor 131 while passing by the motor and then goes out of outlet 134.

Hermetically disposed, electric connection terminal 139 penetrates through metal housing 132 so as to be connected to a winding of motor 131 inside metal housing 132, and to be connected to an inverter device (not shown) outside metal housing 132.

FIG. 9 is a front view of electric connection terminal 139. FIG. 10 is a plan view of the terminal. Pin-terminal holders 113 with electrical insulation are fixed to base 112. Pin-terminal holders 113 hold pin terminals 141 for establishing electrical connection. Each of pin terminals 141 contains tab 142 and tab 114 that is disposed on the back surface by welding. Tab 142 and tab 114 have connections to fasten terminal 144 on which connecting wire 143 is fixed by caulking, as shown in FIG. 11. That is, tab 114 is connected via fasten terminal 144 to the winding of motor 131 inside metal housing 132, whereas tab 142 is connected via fasten terminal 144 to the inverter device outside metal housing 132.

For structuring the connecting line as short as possible between the electrically driven compressor and the inverter device, some suggestions have been made. One of them is disclosed in Japanese Patent Unexamined Publication No. 2000-255252. FIG. 12 shows a plan view illustrating the conventional connection between electrically driven compressor 150 and inverter device 160. Bus bar 170 connects between output terminal 162 of inverter device 160 and input terminal 152 of compressor 150. In the connection above, compressor 150 and inverter device 160 are closely disposed to shorten the wiring. At the same time, bus bar 170 is made of a low-resistance material whose surface is coated with a powder mixture of magnetic material. The structure above suppresses power loss and radiation of electromagnetic waves.

According to the aforementioned connection of the electrically driven compressor and the inverter device, however, the compressor needs a tab, a fasten terminal and a connecting wire for electrical connection terminal. On the other hand, the inverter device needs an attachment structure for the connecting wire. Besides, the connecting wire should be a shield wire with a large diameter. The necessities above increase a parts count and an installation space, which is an obstacle to a compact and lightweight structure. In addition, the assembly process increases due to increase in parts count.

On the other hand, a soldered connection has following problems. Conventionally, a pin terminal has been made of alloys of iron or the like from the necessity of mechanical strength. Due to the large heat capacity of the alloys, the soldering work requires a heating device with large capacity. Besides, the soldering work has to be carefully carried out so as not to overheat connecting components and peripheral components. The conventional structure has pending problems above.

### SUMMARY OF THE INVENTION

The electrically driven compressor integrally formed with an inverter device of the present invention has the following structure: a compression mechanism section; a motor as a power source of the compression mechanism section; a metal housing for accommodating the compression mechanism section and the motor; an inverter device with a printed wiring board, which is disposed outside the metal housing and supplies the motor with electricity; and an electric connection terminal for electrically connecting between an inside and an outside of the metal housing. The electric connection terminal has some pin terminal formed of a stainless steel that is a metal with low thermal conductivity and a copper that is a metal with high thermal conductivity. The stainless steel is plated with the copper. The pin terminals are electrically connected to the printed wiring board of the inverter device by a solder.

By virtue of the structure above, the soldered connection to the electric connection terminal can be easily and quickly obtained. This also allows an electrically driven compressor integrally formed with an inverter device to have a compact, lightweight structure and simple assembly work.

### BRIEF DESCRIPTION OF THE DRAWINGS

FIG. 1 is a sectional view showing an electrically driven compressor integrally formed with an inverter device, with the essential part cut away, in accordance with a first exemplary embodiment of the present invention.

FIG. 2 is an electric circuit diagram of the structure in accordance with the first exemplary embodiment.

FIG. 3 is a front view of an electric connection terminal in accordance with the first exemplary embodiment.

FIG. 4 is a plan view of the electric connection terminal in accordance with the first exemplary embodiment.

FIG. 5 is a sectional view showing the essential part of the electric connection terminal in accordance with the first exemplary embodiment.

FIG. 6A is an electric circuit diagram of the structure in accordance with a second exemplary embodiment.

FIG. 6B illustrates voltages applied to the structure in accordance with the second exemplary embodiment.

FIG. 7 shows a vehicle air conditioner that employs the electrically driven compressor integrally formed with the inverter device in accordance with a third exemplary embodiment.

FIG. 8 is a sectional view of a conventional electrically driven compressor, with the essential part cut away.

FIG. 9 is a front view of an electric connection terminal of the electrically driven compressor shown in FIG. 8.

FIG. 10 is a plan view of the electric connection terminal of the electrically driven compressor shown in FIG. 8.

FIG. 11 is a perspective view of a fasten terminal of the electrically driven compressor shown in FIG. 8.

FIG. 12 is a plan view showing another conventional connection between an electrically driven compressor and an inverter device.

### REFERENCE MARKS IN THE DRAWINGS

8 electric connection terminal
9 solder
10 pin terminal
11 printed wiring board
18 temperature sensor (thermistor)
20 inverter device
28 compression mechanism section
31 motor
32 metal housing

### DETAILED DESCRIPTION OF THE PREFERRED EMBODIMENTS

### First Exemplary Embodiment

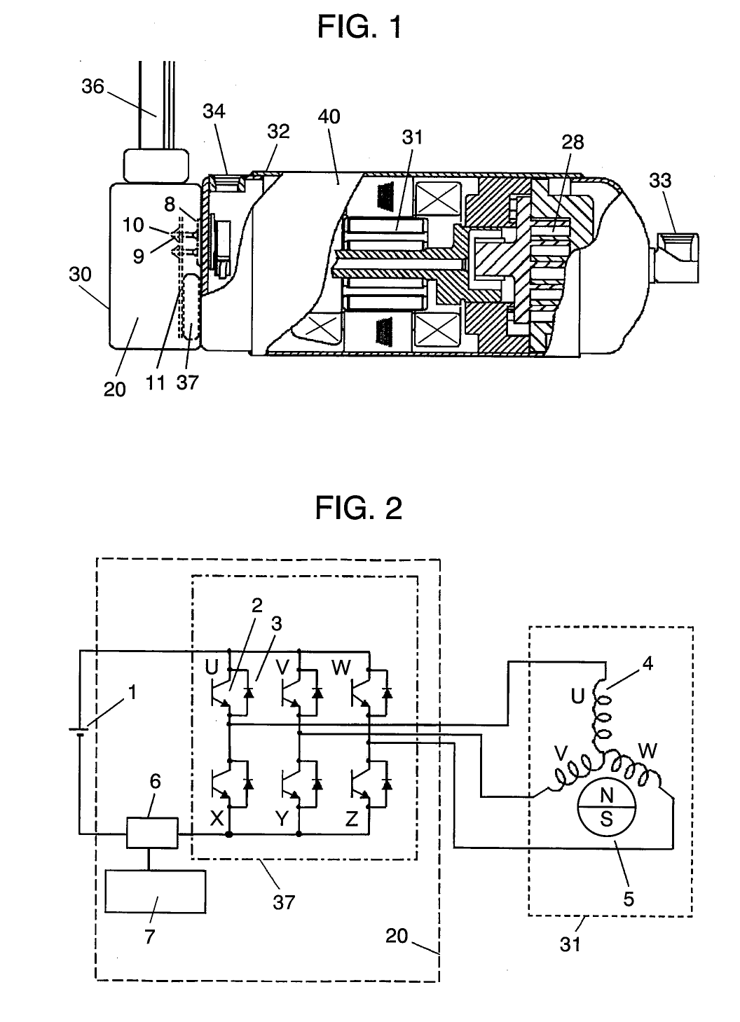

FIG. 1 is a sectional view showing the electrically driven compressor integrally formed with an inverter device, with the essential part cut away, in accordance with a first exemplary embodiment of the present invention. It shows a structure where inverter device 20 is attached on the left side of electrically driven compressor 40. In the structure, metal housing 32 accommodates compression mechanism section 28, motor 31 and the like.

Refrigerant is sucked through inlet 33 and then compressed by compression mechanism section 28, (although a scroll mechanism is used in the example) driven by motor 31. The compressed refrigerant cools motor 31 while passing by the motor and then goes out of outlet 34.

Inverter device 20 contains case 30 so as to be attachable to electrically driven compressor 40. Inverter circuit 37, which is the main heat source of inverter device 20, dissipates heat via case 30 to metal housing 32 of compressor 40. That is, refrigerant in compressor 40 cools down inverter circuit 37 via metal housing 32. Lead wire 36 from inverter device 20 includes a power line connected to DC power source 1, a signal line for controlling an air conditioning controller (not shown) and the like.

In the inside of metal housing 32, pin terminal 10 of electric connection terminal 8 is connected to the winding of motor 31 by a fasten terminal, and in the outside of metal housing 32, pin terminal 10 is connected to inverter device 20. Pin terminal 10 of electric connection terminal 8 is connected to printed wiring board 11 of inverter device 20 with solder 9. Printed wiring board 11 connects between pin terminal 10 and inverter circuit 37.

FIG. 2 is an electric circuit diagram of the structure in accordance with the first exemplary embodiment. Inverter device 20 contains inverter circuit 37, current sensor 6, control circuit 7 and the like. Printed wiring board 11, on which current sensor 6 and circuits including control circuit 7 are arranged, has connections to inverter circuit 37.

In FIG. 2, control circuit 7 detects a position of magnet rotor 5 by calculating current values fed from current sensor 6. According to an rpm instruction signal received from an air conditioning controller (not shown), control circuit 7 controls switching element 2 so that DC current from DC power source 1 is converted into AC current with a sinusoidal wave. The AC current is fed from inverter circuit 37 to sensorless DC brushless motor 31 formed of stator winding 4 and magnet rotor 5. Diode 3 forms a return route of current from stator winding 4.

The main heat source of inverter device 20 is inverter circuit 37 containing switching element 2 and diode 3, which converts DC current into sinusoidal wave-shaped AC current and outputs it to motor 31.

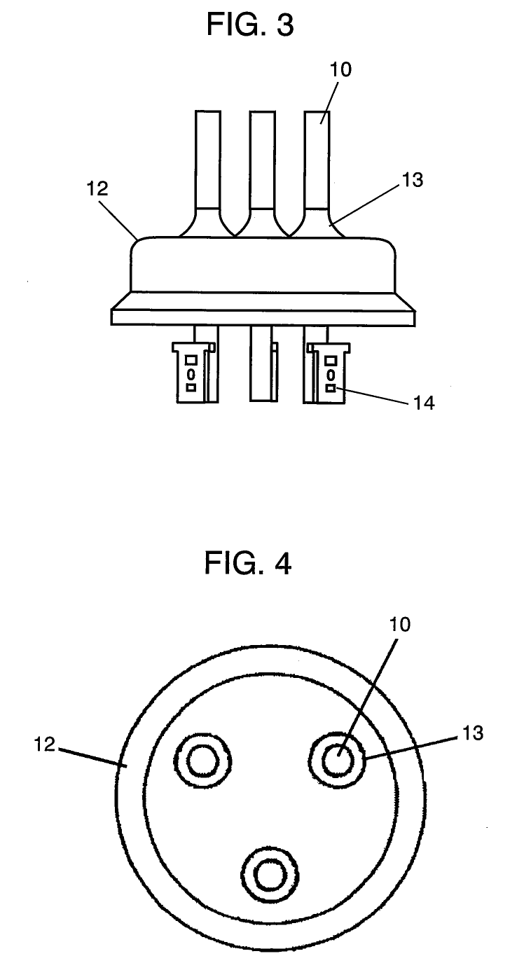

FIG. 3 and FIG. 4 are a front view and a plan view, respectively, of electric connection terminal 8 in accordance with the first exemplary embodiment. Base 12, pin-terminal holder 13 with electrical insulation and tab 14 in FIGS. 3 and 4 are the same as those of conventional electric connection terminal 139. However, pin terminal 10 of the exemplary embodiment has no component corresponding to tab 142 of the conventional structure, which is disposed for making connections to the inverter device via fasten terminal 144.

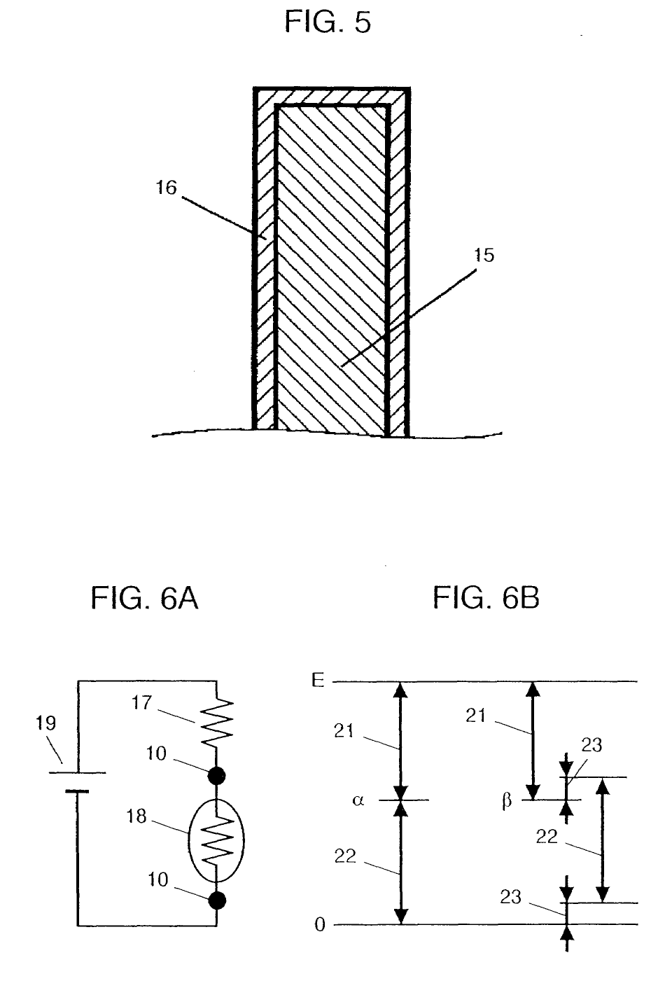

FIG. 5 is a sectional view showing the essential part of electric connection terminal 10. Stainless-steel rod 15 as a base of pin terminal 10 is plated with copper plating 16. The plating is given to the base by commonly used electrolytic plating. For example, stainless-steel rod 15 with a diameter of 3 mm is plated with approx. 30 μm of copper plating 16.

Prior to the soldered connection of pin terminal 10 to printed wiring board 11, pin terminal 10 needs to be heated for promoting solderability of melted solder 9. By virtue of high thermal conductivity of copper plating 16, the plated surface is quickly heated by a soldering iron. However, the heat of copper plating 16 transmitted to the inside of the plating is not much because of low thermal conductivity of stainless-steel rod 15. That is, heat dissipation to stainless-steel rod 15 is suppressed. Besides, as is apparent from the plating thickness of approx. 30 μm, the surface of stainless-steel rod 15 retains an extremely small amount of copper plating 16 with high thermal conductivity.

Therefore, pin terminal 10 is heated with a little amount of heat. This allows soldered connection to be obtained easily and quickly. Besides, the brief period of heating time with a soldering iron and the like suppresses thermal stress on printed wiring board 11, enhancing reliability in performance.

If pin terminal 10 is formed of metals all of which has high thermal conductivity, the heat given to pin terminal 10 is dissipated to the fasten terminal and the connecting wire on the side of motor 31, so that the soldered connection with solder 9 will be difficult. On the other hand, if pin terminal 10 is formed of metals all of which has low thermal conductivity, pin terminal 10 is hard to be heated, so that the soldered connection with solder 9 will also be difficult.

The aforementioned structure eliminates conventionally required tab, fasten terminal, connecting wire and attachment structure for the connecting wire, allowing an electrically driven compressor with an inverter device to have a compact and lightweight body. At the same time, the structure is completed by easy assembly work.

As for base 12, pin-terminal holder 13 and tab 14 of electric connection terminal 8, the structure of the present invention shares with those of conventional electric connection terminal 139, thereby suppressing increase in a parts count. The structure of the present invention can be easily obtained in a manner that inverter device 20 is fixed on the left side of electrically driven compressor 40 that is the same as conventional compressor 106 except for electric connection terminal 8. Besides, employing an electromagnetic-shielding material for case 30 prevents radiation of electromagnetic waves.

Although the structure of the embodiment employs stainless-steel as a metal with low thermal conductivity, it is not limited thereto; the same effect is obtained by iron or other iron alloys. Similarly, the structure of the embodiment employs copper as a metal with high thermal conductivity, it is not limited thereto; the same effect is obtained by gold or silver. The combination of a metal with low thermal conductivity and a metal with high thermal conductivity should be selected in consideration of the following points: the mechanical strength of the pin terminal; solderability; and thermal effects on connecting components and peripheral components in soldering work. It will be understood that at least a metal used for plating has thermal conductivity higher than that used for core rod section.

Solder, which is a metal alloy with relatively low melting point, is used for joining metals. Solder contains soft solder and hard solder. Although pin terminal 10 is directly soldered to printed wiring board 11 with solder 9 in the embodiment, it is not limited thereto; for example, a short lead wire or a bus bar may be disposed between them. Although the embodiment introduces electrically driven compressor 40 as a high-pressure compressor in which high-pressure refrigerant cools the motor, the structure is applicable to a low-pressure compressor in which low-pressure refrigerant cools the motor.

### Second Exemplary Embodiment

The description given in the first embodiment focuses on pin terminal 10 of electric connection terminal 8 that connects between inverter device 20 and motor 31. When temperature sensor 18 is disposed inside metal housing 32 of compressor 40 to detect temperature of the winding of motor 31 and the like, pin terminal 10 is also used for establishing electrical connections between inverter device 20 and temperature sensor 18.

FIG. 6A is an electric circuit diagram showing the aforementioned structure in accordance with the second exemplary embodiment. A low voltage of approx. 5V of DC power source 19 is divided by voltage-dividing resistor 17, temperature sensor 18 (for example, thermistor 18). The both ends of thermistor 18 have electrical connections via pin terminal 10.

Pin terminal 10, since being structured of a metal with high thermal conductivity and a metal with low thermal conductivity, has contact-potential difference. The difference is small but cannot be ignored, because the voltage detected by the temperature sensor is also small. The contact-potential difference can adversely affect voltage detected by the temperature sensor.

However, the structure shown in FIG. 6A addresses the problem above. That is, the structure in which the both ends of thermistor 18 have electrical connections via pin terminal 10 cancels out contact-potential difference between different metals, so that divided voltage is accurately detected.

Next will be described the structure of the second embodiment with reference to FIG. 6B that illustrates divided voltage (where, E represents voltage of DC power source 19).

In a structure with no use of pin terminal 10, as is shown in the left part in FIG. 6B, voltage E is divided into voltage 21 of voltage-dividing resistor 17 and voltage 22 of thermistor 18. Divided voltage a, which is detected by thermistor 18, is fed into inverter device 20.

On the other hand, in a structure with the use of pin terminal 10, as is shown in the right part, the upper-side value and the lower-side value of voltage 22 of thermistor 18 shift by the value of contact-potential difference 23, so that contact-potential difference 23 is cancelled out by the value shifted at the upper side and the lower side of voltage 22 of thermistor 18.

As a result, divided voltage β equals to divided voltage α, by which an accurate divided voltage is detected. It is also true when contact-potential difference 23 between different metals takes a negative value.

Pin terminal 10 is not necessarily dedicated for connecting motor 31 or connecting thermistor 18, but may be prepared for both of them or for other components. That is, electric connection terminal 8 does not necessarily has the structure shown in FIG. 3 and FIG. 4; it may contain five or seven pin terminals 10. In addition, the material of each of the pin terminals may be changed according to a device to be connected.

### Third Exemplary Embodiment

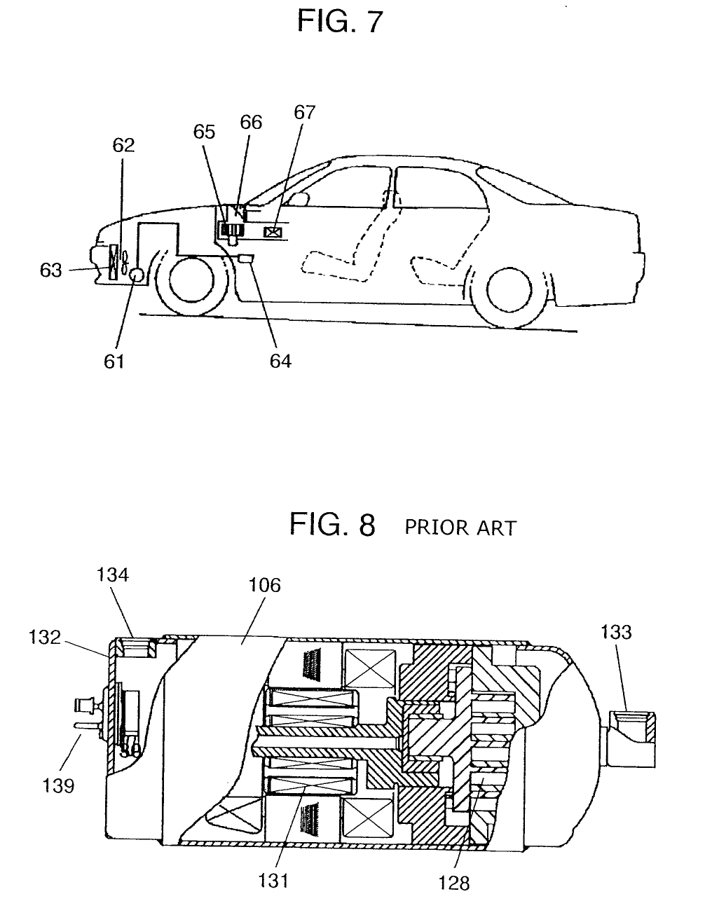

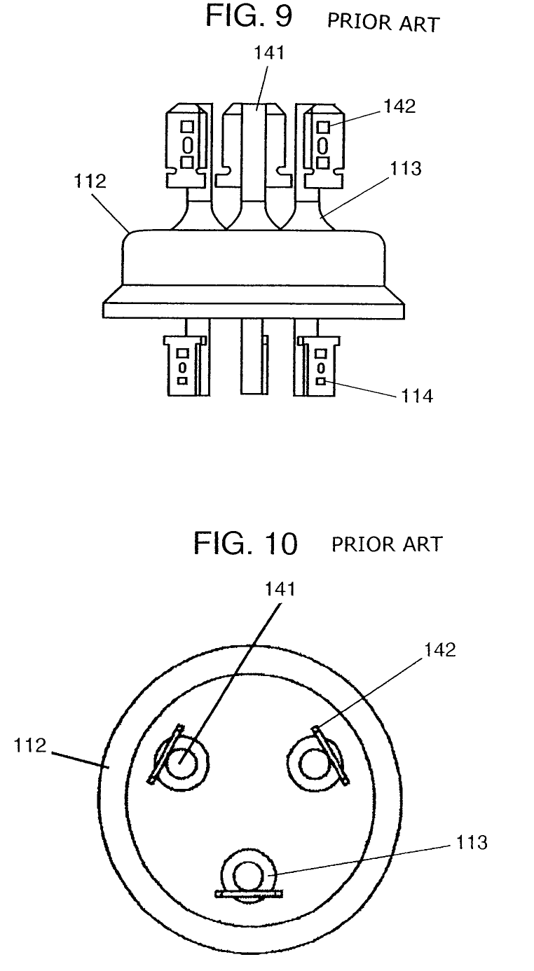

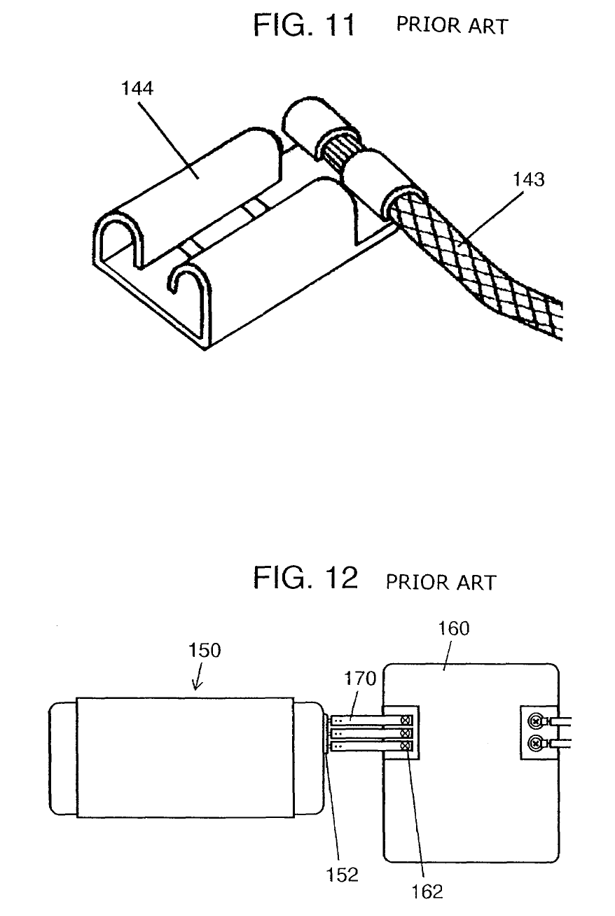

FIG. 7 shows an example in which the electrically driven compressor integrally formed with the inverter device is mounted on a vehicle. Electrically driven compressor 61 with the inverter device, outdoor heat-exchanger 63 and outdoor fan 62 are disposed in the engine room forward of the vehicle. In the interior of the vehicle, indoor fan 65, indoor heat-exchanger 67 and air conditioning controller 64 are disposed. Captured through air inlet 66, outside air undergoes heat exchange in indoor heat-exchanger 67 and then flows into the interior of the vehicle.

Vehicles, in particular, electric vehicles and hybrid vehicles need a compact and lightweight air conditioner in terms of attainment of reliable driving performance and constraints on the installation space. Under the circumstances, it has become a critical challenge for an electrically driven compressor that reducing its size and weight so as to be disposed in the space-limited engine room or other narrow spaces.

The structure described in the first exemplary embodiment allows the electrically driven compressor with the inverter device to have a downsized and lightweight body. It is therefore highly suitable for a vehicle air conditioner.

### INDUSTRIAL APPLICABILITY

According to the present invention, as described above, a soldered connection to the electric connection terminal can be easily and quickly carried out. This also contributes to an easily assembled compressor integral with an inverter device having a compact and lightweight body. It is particularly useful for a vehicle air conditioner.

1. An electrically driven compressor integrally formed with an inverter device comprising:
a compression mechanism section;
a motor as a power source of the compression mechanism section;
a metal housing for accommodating the compression mechanism section and the motor;
an inverter device with a printed wiring board, which is disposed outside the metal housing and supplies the motor with electricity; and
an electric connection terminal for electrically connecting between an inside and an outside of the metal housing,
wherein the electric connection terminal contains a pin terminal formed of a stainless steel that is a metal with low thermal conductivity and a copper that is a metal with high thermal conductivity, the stainless steel being plated with the copper and the pin terminal being electrically connected to the printed wiring board of the inverter device by a solder.

2. The electrically driven compressor integrally formed with the inverter device of claim 1, wherein the inverter device supplies the motor with electricity via the electric connection terminal.

3. The electrically driven compressor integrally formed with the inverter device of claim 1, wherein the metal housing further accommodates a temperature sensor, and the temperature sensor is electrically connected to the inverter device via the electric connection terminal.

4. The electrically driven compressor integrally formed with the inverter device of claim 3, wherein the temperature sensor is a thermistor, and the thermistor is electrically connected to the electric connection terminal.

5. (canceled)

6. (canceled)

7. (canceled)

8. The electrically driven compressor integrally formed with the inverter device of claim 1, wherein the inverter device is fixed with the metal housing so as to have an intimate contact.

9. The electrically driven compressor integrally formed with the inverter device of claim 8, wherein the inverter device is cooled down by refrigerant in the compression mechanism via the metal housing.

10. A vehicle air conditioner that employs the electrically driven compressor integrally formed with the inverter device described in any one of claim 1, claim 2, claim 3, claim 4, claim 8 and claim 9.
